(19) United States
(12) Patent Application Publication
(10) Pub. No.: US 2026/0291812 A1
(43) Pub. Date: Sep. 24, 2026

(54) NETWORK SLICING ONBOARDING SYSTEM FOR PROVIDING CLOSED NETWORK SERVICE, AND METHOD THEREOF

(71) Applicant: NETCUBE INC, Seoul (KR)

(72) Inventor: Dong Ho YU, Seoul (KR)

(21) Appl. No.: 18/719,220

(22) PCT Filed: Dec. 20, 2021
(86) PCT No.: PCT/KR2021/019435

§ 371 Date: Jun. 3, 2026

(30) Foreign Application Priority Data
Dec. 20, 2021 (KR) 10-2021-0182381

(51) Int. Cl. H04L 41/0895; H04L 9/40; H04L 41/0806; H04L 41/5003; H04W 8/18

(52) U.S. Cl. CPC H04L 41/0895; H04L 41/0806; H04L 41/5003; H04L 63/0209; H04W 8/18

(57) ABSTRACT

A network slicing onboarding system according to an embodiment of the present invention comprises: a service application reception unit for receiving information requesting a closed network use service, from a dedicated network slice app installed in a user terminal; a service subscription checking unit for checking whether a network slice service is subscribed and information on a mobile communication network linkage policy in response to the information requesting the closed network use service; a network slice profile configuration unit for configuring a network slice profile enabling a PDU session to be established for a network slice corresponding to the closed network use service through a network slice agent of the user terminal; and a network slice profile transmission unit for transmitting the network slice profile to the user terminal.

### TECHNICAL FIELD

The present invention relates to a system and method for providing network slicing onboarding in a 5th generation mobile communication (5G) system.

More specifically, the present invention relates to an onboarding system capable of supporting a dedicated network slice service and a method thereof, which constructs a closed network such as internal Wi-Fi using a 5G mobile communication network and provides access control thereof.

### BACKGROUND ART

Recently, various techniques are introduced in the mobile communication system to meet rapidly increasing data traffic and demands for various services. The 5th generation mobile communication service, of which the standardization is under progress, is achieving technical advancements such as extremely fast speed and ultra-low latency compared to those of existing 4th generation LTE. Based on this, the possibility of realizing mobile-based application services, which are unable before, such as V2X (autonomous vehicles), drone control, telemedicine, and the like is increasing gradually.

Meanwhile, in the existing 4th generation mobile communication systems, specific application services may not be guaranteed under differentiated conditions since all subscribers in the network share common network resources. However, future applications pursued in the 5th generation mobile communication system may be operated only when more than specific criteria are guaranteed from the aspect of transmission speed, response delay time of a communication network, and the like.

To be distinguished from the applications of the 4th generation mobile communication systems that provide common network resources by sharing horizontally, applications that require different network requirements are referred as vertical applications.

The 5th generation mobile communication systems adopt a virtualized network architecture to accommodate these vertical applications, and through the virtualized network architecture, a network slice, which is a virtual closed network that satisfies high-level network requirements such as high resolution, high speed, and the like, may be allocated to each vertical application service.

Unlike existing mobile communication systems such as LTE, 5G applications may operate on user terminals on the basis of a virtual dedicated mobile communication network while ensuring the performance required for each application through end-to-end traffic separation and resource separation.

Using these characteristics, 5G communication networks may be used as a mobile communication network to provide a service through a network slice that guarantees a specific speed and service quality or implement a closed network with enhanced security through a network slice such as an internal Wi-Fi of a specific organization.

In order to use the network slicing like this, an onboarding procedure of confirming application for network slice subscription and authority of a 5G user and performing provisioning is required.

However, a solution for comprehensively and efficiently performing an onboarding process for network slices of a plurality of vertical applications on a user terminal has not been presented yet.

Accordingly, it is required to introduce a system that comprehensively and efficiently provides a vertical slicing onboarding procedure that allows a user terminal premium streaming or access to an internal network of an organization.

### DETAILED DESCRIPTION OF THE INVENTION

### Technical Problem

Therefore, the present invention has been made in view of the above problems, and it is an object of the present invention to provide a system and method for comprehensively and efficiently performing network slice service using a network slice app and a network slice agent in network slicing onboarding.

In addition, the present invention provides a system and method for efficiently performing confirmation of subscription and authority of network slice service and allocation of resources using a network slice profile.

In addition, the present invention provides a system and method that can efficiently perform network slicing onboarding for providing high-speed or high-resolution premium streaming service or accessing closed networks that require optional security.

Technical problems to be solved by the present invention are not limited to the technical problems mentioned above, and unmentioned other technical problems can be clearly understood by those skilled in the art from the following description.

### Technical Solution

To accomplish the above objects, according to one aspect of the present invention, there is provided a network slicing onboarding system comprising: a service application reception unit for receiving information on application for a closed network use service from a dedicated network slice app installed in a user terminal; a service subscription confirmation unit for confirming whether a network slice service is subscribed and information on a mobile communication network interconnection policy in response to the service application information; a network slice profile setting unit for setting a network slice profile that allows a PDU session to be established for a network slice corresponding to the closed network use service through a network slice agent of the user terminal; and a network slice profile transmission unit for transmitting the network slice profile to the user terminal.

Here, the network slice profile may further include information on Network Slice Selection Assistance Information (NSSAI) used for selecting and using the network slice, or Data Network Name (DNN) for identifying a data network.

Here, the closed network use service may be a 5G-based internal wireless business network service, and the network slice profile may further include service QoS information specifying a quality and a grade of the use service.

In addition, the onboarding system may further comprise a network slice agent providing unit for providing the network slice agent to the user terminal.

Here, the network slicing onboarding system may be implemented on a Demilitarized Zone (DMZ) network blocked by a firewall from a network slice service system that provides the network slice service.

In addition, the network slicing onboarding system may further comprise a firewall setting unit for setting and managing the firewall that maintains security with respect to the network slice service system or the mobile communication network.

According to another aspect of the present invention, there is provided a network slicing onboarding method comprising: a service subscription application reception step of receiving information on application for a closed network use service from a dedicated network slice app installed in a user terminal; a service subscription confirmation step of confirming whether a network slice service is subscribed and information on a mobile communication network interconnection policy in response to the information on application for a closed network use service; a network slice profile setting step of setting a network slice profile that allows a PDU session to be established for a network slice corresponding to the closed network use service through a network slice agent of the user terminal; and a network slice profile transmission step of transmitting the network slice profile to the user terminal.

Here, the network slicing onboarding method may further comprise a network slice agent providing step of providing the user terminal with the network slice agent capable of establishing a PDU session of the network slice using the network slice profile.

In addition, the network slice profile may further include information on Network Slice Selection Assistance Information (NSSAI) used for selecting and using the network slice, or Data Network Name (DNN) for identifying a data network.

Here, the closed network use service may be a 5G-based internal wireless business network service, and the network slice profile may further include service QoS information specifying a quality and a grade of the use service.

### Advantageous Effects

According to the present invention, a user terminal may comprehensively perform a procedure of applying for a service, confirming authority, allocating resources, and using a PDU session-based service using a dedicated network slice app and a network slice agent.

In addition, according to an embodiment of the present invention, a network slice agent may comprehensively perform various network slice-based dedicated network applications by using a network slice profile.

The effects of the present invention are not limited to the effects described above, and should be understood to include all effects that can be inferred from the configuration of the present invention described in the detailed description or claims of the present invention.

### BRIEF DESCRIPTION OF THE DRAWINGS

FIG. 1 a view showing an environment in which a network slicing onboarding system according to an embodiment of the present invention operates.

FIG. 2 is a block diagram showing the configuration of a network slicing onboarding system according to an embodiment of the present invention.

FIG. 3 is a view showing an example of data used in a network slicing onboarding system according to an embodiment of the present invention.

FIG. 4 is a view showing a service process using a network slice according to an embodiment of the present invention.

FIG. 5 is a block diagram showing the configuration of authentication of a network slice dedicated network according to an embodiment of the present invention.

FIG. 6 is a sequence chart showing a network slicing onboarding method according to an embodiment of the present invention.

FIG. 7 is a view showing an onboarding procedure of a network slice that provides a closed network service according to an embodiment of the present invention.

### BEST MODE FOR CARRYING OUT THE INVENTION

Hereinafter, the present invention will be described with reference to the accompanying drawings. However, the present invention may be implemented in several different forms, and thus is not limited to the embodiments described herein. In addition, in order to clearly explain the present invention in the drawings, parts unrelated to the description are omitted, and similar reference numerals are attached to similar parts throughout the specification.

Throughout the specification, when a part is “linked (connected, contacted, coupled)” to another part, it includes the cases of being “indirectly connected” with intervention of another member therebetween, as well as the cases of being “directly connected”. In addition, when a part “includes” a certain component, this means that other components may be further provided, rather than excluding other components, unless clearly stated otherwise.

The terms used in this specification are used only to describe specific embodiments, and are not intended to limit the present invention. Singular expressions include plural expressions unless the context clearly dictates otherwise. It should be understood that in this specification, terms such as “comprise” or “have” are intended to specify existence of a feature, number, step, operation, component, part, or a combination thereof described in the specification, not to preclude the possibility of existence or addition of one or more other features, numbers, steps, operations, components, parts, or combinations thereof.

In this specification, a “module” includes a unit configured of hardware, software, or firmware, and may be used interchangeably with the terms, such as logic, logic block, part, circuit, or the like. A module may be a part configured as one body, a minimum unit that performs one or more functions, or a part thereof. For example, the module may be configured as an application-specific integrated circuit (ASIC).

Chapter 5.15 of TS23.501 of the 3rd Generation Partnership Project (3GPP), which is establishing the 5th generation mobile communication system standards, presents network slicing that supports vertical applications (3GPP TS23.501 chapter 5.15) and technical standards (3GPP TS23.501 chapter 5.15.10) that allows each vertical application system to manage subscribers accessing its own network slices through an independent authentication system. Here, the network slice is a virtual dedicated mobile network that satisfies a specific service quality.

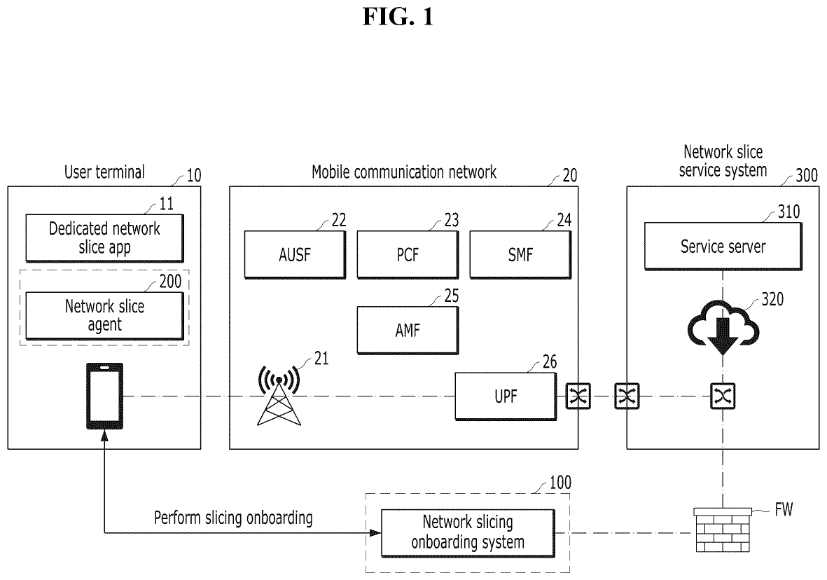

FIG. 1 a view showing an environment in which a network slicing onboarding system according to an embodiment of the present invention operates.

In performing network slicing onboarding, a user terminal 10 includes a dedicated network slice app 11 and a network slice agent 200. The user terminal may be various smart devices connected to a 5G mobile communication network and may be equipped with a communication module and a display module.

A network slice service system 300 may be a service system that provides services satisfying a specific service quality. For example, the services may be a streaming service that provides multimedia contents, a service dedicated to autonomous driving, a service for smart factory IoT, or a virtual organization internal closed network service implemented in a 5G mobile communication network.

The network service system 300 may include a service server 310 and a service internal network 320 for providing services, and a plurality of switches capable of communicating with a mobile communication network 20 and a network slicing onboarding system 100.

The mobile communication network 20 is a mobile communication network that follows the 5G communication standards. The 5G mobile communication network 20 may include a base station 21, and AUSF 22, PCF 23, SMF 24, AMF 25, and UPF 26 as network function units.

The base station 21 performs wireless communication of an RF frequency band with the user terminal 10.

The Access and Mobility Function (AMF) 25 supports mobility using subscriber authentication data, and the Authentication Server Function (AUSF) 22 performs user terminal authentication using subscriber authentication data.

The Session Management Function (SMF) 24 manages session maintenance/release for a plurality of connection sessions, and the Policy Control Function (PCF) 23 determines policies regarding mobility and session management.

The User Plane function (UPF) 26 transfers packets transferred from the user terminal to the data network (DN).

The network slicing onboarding system 100 performs onboarding of a network slice between the network slice system 300 and the user terminal 10. The network slicing onboarding system 100 may be implemented on a Demilitarized Zone (DMZ) network blocked from the network slice service by a firewall, and may be implemented as a web server or an FTP server to be accessed from the outside.

The network slicing onboarding system 100 implemented like this supports the user terminal 10 to use the network slice by confirming service subscription and authority of the user, installing a network slice profile, and distributing the network slice agent 200.

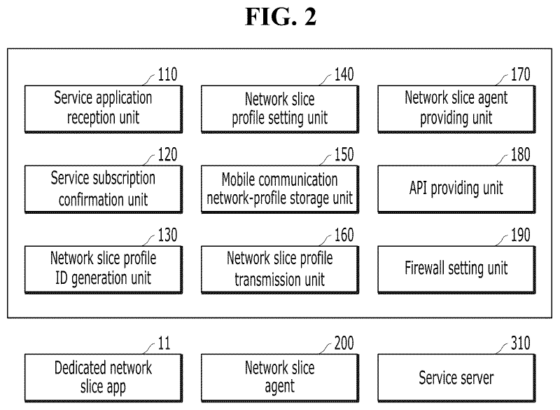

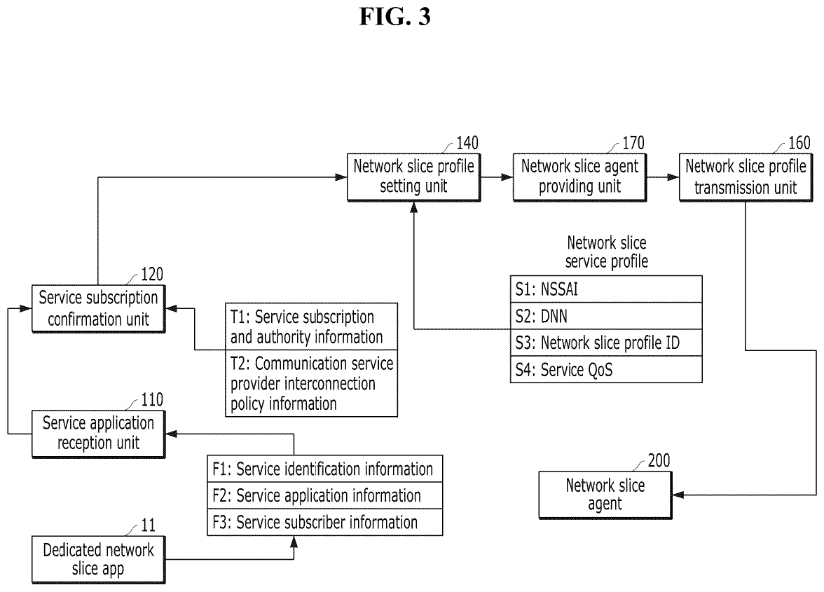

The configuration and functions of the network slicing onboarding system 100 will be described in detail with reference to FIGS. 2 and 3.

FIG. 2 is a block diagram showing the configuration of a network slicing onboarding system according to an embodiment of the present invention.

The network slicing onboarding system 100 may include a service application reception unit 110, a service subscription confirmation unit 120, a network slice profile ID generation unit 130, a network slice profile setting unit 140, a mobile communication network-profile storage unit 150, a network slice profile transmission unit 160, a network slice agent providing unit 170, an API providing unit 180, and a firewall setting unit 190.

The service application reception unit 110 receives information on application for a service from the dedicated network slice app 11.

The service subscription confirmation unit 120 confirms whether or not a user subscribes the network slice service and information on the mobile communication network interconnection policy in response to the service application.

The network slice profile ID generation unit 130 generates an ID of a profile to be set in a network slice assigned for a user whose subscription has been confirmed. The network slice profile ID is an identifier of a profile for setting a dedicated slice corresponding to a specific network slice service.

The network slice profile setting unit 140 includes the network slice profile ID and generates a profile that allows a user terminal to use the network slice.

The generated network slice profile is stored in the mobile communication network-profile storage unit 150 and provided to the user terminal through the network slice profile transmission unit 160.

The network slice agent providing unit 170 provides a network slice agent that allows the user terminal to establish a PDU session using the network slice profile.

The API providing unit 180 provides an API that allows the dedicated network slice app 11 to add a function of operating in connection to the network slicing onboarding system 100.

The firewall setting unit 190 sets and manages a firewall that maintains security with respect to the network slice service system or mobile communication networks with which the network slicing onboarding system 100 communicates.

FIG. 3 is a view showing an example of data used in a network slicing onboarding system according to an embodiment of the present invention.

As described above, the dedicated network slice app 11 may be one of apps that provide various vertical applications. For example, it may be an OTT app that provides high-speed high-quality streaming service. In addition, it may be a virtual internal network access app that may use data by accessing an internal wireless business network of a specific organization or company or a closed network such as Wi-Fi.

The dedicated network slice app 11 may use a network slice and has a function of supporting service subscription and network slicing onboarding for a user terminal on which onboarding of a network slice has not been performed. For example, the dedicated network slice app 11 may provide an interface of a service subscription button, and transmits service application data to the service application reception unit 110 through the interface.

The service application data may include service identification information F1, service application information F2, and service subscriber information F3 of the network slice.

Using the information F1, F2, and F3, the service subscription confirmation unit 120 refers to service subscription and authority information T1 and communication service provider interconnection policy information T2 for authentication of authority.

When service subscription is confirmed and authentication of authority is completed, the network slice profile setting unit 140 sets a network slice profile so that the service subscriber of the user terminal may use the network slice.

The network slice profile includes information on the Network Slice Selection Assistance Information (NSSAI) S1 used for selecting and using a network slice, Data Network Name (DNN) S2 that identifies a data network, network slice profile ID S3 fixed to or dynamically assigned to a specific network slice to be used by the user, or service QoS S4 that specifies the quality and grade of service.

The network slice agent 200 distributed to the user terminal may use a network slice service by utilizing the network slice profile described above.

The network slice agent 200 decodes or decrypts information on the network slice profile generated by the network slicing onboarding system 100 and provides the information so that the 5G network slice service may be used in the mobile communication network. The network slice agent 200 may use the received network slice profile to support flow of network slice-based dedicated network application data until the network slice profile is updated.

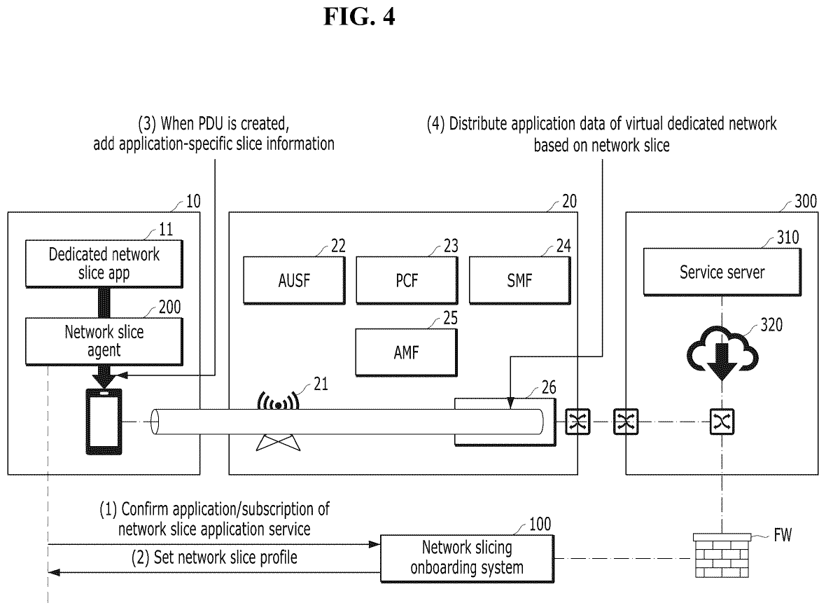

FIG. 4 is a view showing a service process using a network slice according to an embodiment of the present invention.

As described above, the network slicing onboarding system 100 receives an application for a service of a network slice app and confirms subscription through the dedicated network slice app 11.

When subscription is confirmed, the network slicing onboarding system 100 sets and provides a network slice profile to the network slice agent 200, and the network slice agent 200 adds application-specific slice information with reference to the network slice profile information when a PDU session is established.

The established PDU session creates a tunnel for a service dedicated to the network slice, and the PDU session supports flow of data of a network slice-based virtual dedicated network.

For example, a network slice is generated by a virtual dedicated network that provides high-quality media streaming of 8K, and may be provided with high-quality media streaming of a corresponding quality.

Alternatively, a dedicated network capable of accessing a closed network of an organization or a company may be created, and a PDU session having an authority capable of accessing a specific folder or the like of the closed network may also be established.

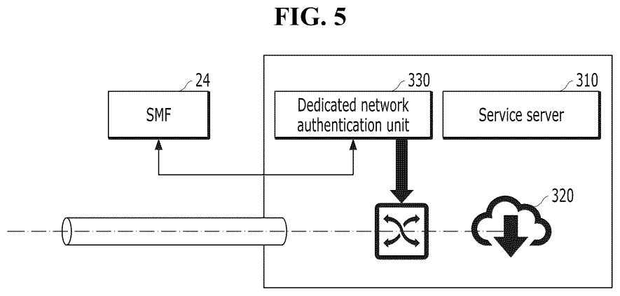

FIG. 5 is a block diagram showing the configuration of authentication of a dedicated network slice network according to an embodiment of the present invention.

When the network slice service system 300 supports a specific quality or provides a dedicated network service that only a user authenticated with a specific authority may access, the dedicated network authentication unit 300 may perform authentication for using the dedicated network.

A dedicated network authentication unit 330 may support a user terminal connecting through the established PDU session to access the internal network 320 through the established PDU session by communicating with the SMF 24 and confirming whether the user terminal may access the internal network 320 and controlling the switch.

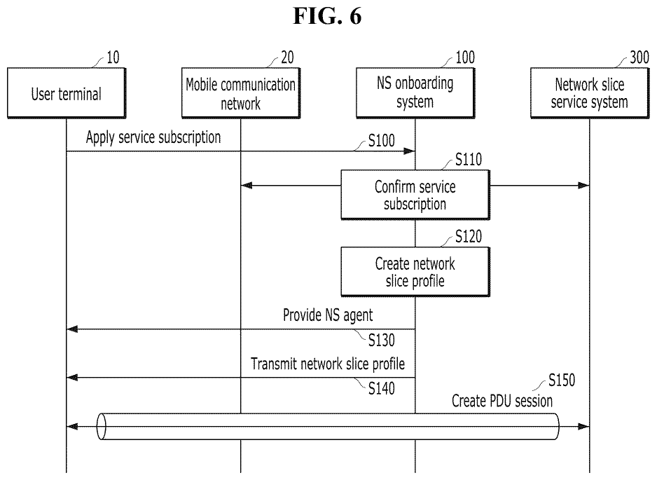

FIG. 6 is a sequence chart showing a network slicing onboarding method according to an embodiment of the present invention.

At step S100, the user terminal 10 transmits a service subscription application to the network slicing onboarding system 100. The service subscription application may use a function provided to the dedicated network slice app installed in the user terminal 10. The service subscription application function may also be implemented later using an API distributed by the network slicing onboarding system 100. The service application data may include service identification information F1, service application information F2, and service subscriber information F3 of a network slice.

In response to the service subscription application, the network slicing onboarding system 100 communicates with the network service system 300 or the mobile communication network 20 and confirms service subscription (S110). To confirm service subscription, the network slicing onboarding system 100 refers to the service subscription and authority information T1 and the communication service provider interconnection policy information T2.

When service subscription is confirmed, the network slicing onboarding system 100 creates a network slice profile used for using a network slice-based application (S120). The network slice profile may include information on the Network Slice Selection Assistance Information (NSSAI) S1 used for selecting and using a network slice, Data Network Name (DNN) S2 that identifies a data network, network slice profile ID S3 fixed to or dynamically assigned to a specific network slice to be used by the user, or service QoS S4 that specifies the quality and grade of service.

Meanwhile, when the user terminal 10 does not have a network slice agent, the network slicing onboarding system 100 provides a network slice agent and performs installation (S130).

The network slice agent 200 decodes or decrypts information on the network slice profile generated by the network slicing onboarding system 100 and provides the information so that the 5G network slice service may be used in the mobile communication network. The network slice agent 200 may use the received network slice profile to support flow of network slice-based dedicated network application data until the network slice profile is updated.

At step S140, the network slicing onboarding system 100 transmits the network slice profile, and the network slice agent may establish a PDU session between the user terminal 20 and the network service system 200 using the information included in the network slice profile and provide a dedicated service (S150).

The established PDU session creates a tunnel for a service dedicated to the network slice, and the PDU session supports flow of data of a network slice-based virtual dedicated network.

For example, a network slice is generated by a virtual dedicated network that provides high-quality media streaming of 8K, and may be provided with high-quality media streaming of a corresponding quality.

Alternatively, a dedicated network capable of accessing a closed network of an organization or a company may be created, and a PDU session having an authority capable of accessing a specific folder or the like of the closed network may also be established.

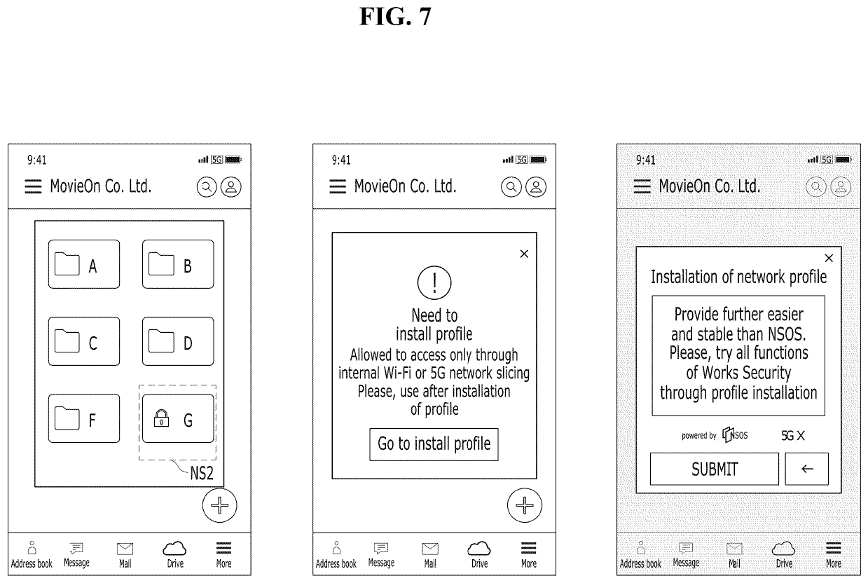

FIG. 7 is a view showing an onboarding procedure of a network slice that provides a closed network service according to an embodiment of the present invention.

As shown in FIG. 7, the dedicated network slice app that provides an internal network of an organization (MovieOn) provides six storage spaces of A, B, C, D, F, and G inside the internal network.

Here, the storage spaces A, B, C, D, and F store data that can be accessed through user authentication of a dedicated app. However, a service corresponding to storage space G (NS2) stores work data that requires security, and the data in storage space G may only be accessed through authentication of an internal dedicated network or internal Wi-Fi. The internal Wi-Fi corresponds to a closed network that can be accessed only through a user and a device authenticated in advance within an area corresponding to the Wi-Fi coverage, and when the user and the device are not registered in the closed network, storage space G may not be accessed.

Meanwhile, the network slice service of 5G may construct a network slice as a closed network like internal Wi-Fi. Therefore, an organization may construct a closed network that provides communication quality provided by 5G while maintaining security like the internal Wi-Fi.

When a user selects a service (NS2), the network slicing onboarding system (NSOS) 100 may provide an interface for the service subscription application. When a user applies for service subscription through the interface, the network slicing onboarding system 100 performs confirmation of authority and assigns and creates a network slice ID as described above. In addition, the network slicing onboarding system may create a network slice profile and distribute a network slice agent that can use the network slice profile to the user terminal.

When the network slice agent comes to able to use the network slice profile installed in the user terminal, an installation completion screen is provided to the user, and the user terminal may connect to and access storage space G of the closed network based on the speed and quality predetermined in the network slice service (NS2).

The method according to an embodiment of the present invention described above may be implemented in the form of program instructions that can be executed through various computer components, and recorded in a computer-readable recording medium. The computer-readable recording medium may include program instructions, data files, data structures, and the like alone or in combination. The program instructions recorded in the computer-readable recording medium may be specially designed and configured for the embodiments of the present invention, or may be known and available to those skilled in the art of computer software field. The computer-readable recording medium includes hardware configured to store and execute program instructions, such as a magnetic recording medium including a hard disk, a floppy disk, and a magnetic tape, an optical recording medium including a CD-ROM and a DVD, a magneto-optical medium including a floptical disk, ROM, RAM, flash memory, and the like. The program instructions include machine codes generated by a compiler, and high-level language codes that can be executed in a computer using an interpreter. The hardware may be configured to operate by one or more software modules to process the method according to the present invention, and vice versa.

The method according to an embodiment of the present invention may be executed in an electronic device in the form of a program instruction. The electronic device includes a portable communication device such as a smart phone, a smart pad or the like, a computer device, a portable multimedia device, a portable medical device, a camera, a wearable device, and a home appliance device.

The method according to an embodiment of the present invention may be provided to be included in a computer program product. The computer program product is a merchandise and may be traded between sellers and buyers. The computer program product may be distributed in the form of a device-readable recording medium or online through an application store. In the case of online distribution, at least some of the computer program products may be temporarily stored or temporarily generated in a storage medium such as a memory of a manufacturer server, an application store server, or a relay server.

Each of the components, for example, a module or a program, according to an embodiment of the present invention may be configured as a single sub-component or a plurality of sub-components, and some of the sub-components may be omitted, or other sub-components may be further included. Some components (modules or programs) may be integrated into a single entity to perform the same or similar functions performed by each corresponding component before the integration. Operations performed by the modules, programs, or other components according to an embodiment of the present invention may be executed sequentially, in parallel, repetitively, or heuristically, or at least some of the operations may be executed in a different order or omitted, or other operations may be added.

The description of the present invention described above is for illustrative purposes, and those skilled in the art may understand that it can be easily modified into other specific forms without changing the technical spirit or essential features of the present invention. Therefore, it should be understood that the embodiments described above are illustrative in all respects and not restrictive. For example, each component described as a single type may be implemented in a distributed form, and components described as distributed may also be implemented in a combined form likewise.

The scope of the present invention is indicated by the following claims, and all changes or modifications derived from the meaning and scope of the claims and their equivalents should be construed as being included in the scope of the present invention.

1. A network slicing onboarding system comprising:
a service application reception unit for receiving information on application for a closed network use service from a dedicated network slice app installed in a user terminal;
a service subscription confirmation unit for confirming whether a network slice service is subscribed and information on a mobile communication network interconnection policy in response to the service application information;
a network slice profile setting unit for setting a network slice profile that allows a PDU session to be established for a network slice corresponding to the closed network use service through a network slice agent of the user terminal; and
a network slice profile transmission unit for transmitting the network slice profile to the user terminal.

2. The system according to claim 1, wherein the network slice profile further includes information on Network Slice Selection Assistance Information (NSSAI) used for selecting and using the network slice, or Data Network Name (DNN) for identifying a data network.

3. The system according to claim 2, wherein the closed network use service is a 5G-based internal wireless business network service, and the network slice profile further includes service QoS information specifying a quality and a grade of the use service.

4. The system according to claim 2, further comprising a network slice agent providing unit for providing the network slice agent to the user terminal.

5. The system according to claim 1, being implemented on a Demilitarized Zone (DMZ) network blocked by a firewall from a network slice service system that provides the network slice service.

6. The system according to claim 5, further comprising a firewall setting unit for setting and managing the firewall that maintains security with respect to the network slice service system or the mobile communication network.

7. A network slicing onboarding method comprising:
a service subscription application reception step of receiving information on application for a closed network use service from a dedicated network slice app installed in a user terminal;
a service subscription confirmation step of confirming whether a network slice service is subscribed and information on a mobile communication network interconnection policy in response to the information on application for a closed network use service;
a network slice profile setting step of setting a network slice profile that allows a PDU session to be established for a network slice corresponding to the closed network use service through a network slice agent of the user terminal; and
a network slice profile transmission step of transmitting the network slice profile to the user terminal.

8. The method according to claim 7, further comprising a network slice agent providing step of providing the network slice agent to the user terminal.

9. The method according to claim 8, wherein the network slice profile further includes information on Network Slice Selection Assistance Information (NSSAI) used for selecting and using the network slice, or Data Network Name (DNN) for identifying a data network.

10. The method according to claim 9, wherein the closed network use service is a 5G-based internal Wi-Fi service, and the network slice profile further includes service QoS information specifying a quality and a grade of the use service.
